(19) United States
(12) Patent Application Publication
(10) Pub. No.: US 2023/0409335 A1
(43) Pub. Date: Dec. 21, 2023

(54) SELECTIVE DISABLE OF HISTORY-BASED PREDICTORS ON MODE TRANSITIONS

(71) Applicant: Intel Corporation, Santa Clara, CA (US)

(72) Inventors: Mathew Lowes, Austin, TX (US); Jared Warner Stark, IV, Portland, OR (US); Martin Licht, Round Rock, TX (US)

(73) Assignee: Intel Corporation, Santa Clara, CA (US)

(21) Appl. No.: 17/843,179

(22) Filed: Jun. 17, 2022

(51) Int. Cl. G06F 9/38; G06F 9/32

(52) U.S. Cl. CPC G06F 9/3844; G06F 9/321; G06F 9/3806

(57) ABSTRACT

Techniques for selective disable of history-based predictors on mode transitions are described. An example apparatus comprises first circuitry to provide a history-based prediction, and second circuitry coupled to the first circuitry to selectively block and unblock a prediction from the first circuitry after a mode transition. Other examples are disclosed and claimed.

Some central processor unit (CPU) cores may utilize speculative execution to avoid pipeline stalls and achieve better performance, which allows execution to continue without having to wait for the architectural resolution of a branch target. Branch prediction technology utilizes a digital circuit that guesses which way a branch will go before the branch instruction is executed. Correct predictions/guesses improve the flow in the instruction pipeline. In general, a branch prediction for a conditional branch may be understood as a prediction for the branch as “taken” vs. “not-taken.” A branch prediction unit (BPU) may support speculative execution by providing branch prediction for a frond-end of a CPU based on the branch instruction pointer (IP), branch type, and the control flow history (also referred as branch history) prior to the prediction point.

### BRIEF DESCRIPTION OF DRAWINGS

Various examples in accordance with the present disclosure will be described with reference to the drawings, in which:

FIG. 1 is a block diagram of an example of an apparatus that includes selective prediction blocking/unblocking technology in one implementation.

FIGS. 2 to 3 are illustrative diagrams of an example of a method for selectively blocking/unblocking a prediction in one implementation.

FIG. 4 is a block diagram of another example of an apparatus that includes selective prediction blocking/unblocking technology in one implementation.

FIGS. 5 to 7 are illustrative diagrams of an example of a system that includes selective prediction blocking/unblocking technology in one implementation.

FIG. 8 is a block diagram of an example of an out-of-order processor that includes selective prediction blocking/unblocking technology in one implementation.

FIG. 9 illustrates an exemplary system.

FIG. 10 illustrates a block diagram of an example processor that may have more than one core and an integrated memory controller.

FIG. 11A is a block diagram illustrating both an exemplary in-order pipeline and an exemplary register renaming, out-of-order issue/execution pipeline according to examples.

FIG. 11B is a block diagram illustrating both an exemplary example of an in-order architecture core and an exemplary register renaming, out-of-order issue/execution architecture core to be included in a processor according to examples.

FIG. 12 illustrates examples of execution unit(s) circuitry.

FIG. 13 is a block diagram of a register architecture according to some examples.

FIG. 14 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for selective disable/enable of history-based predictors on mode transitions. According to some examples, the technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to provide selective disable/enable of history-based predictors on mode transitions.

In the following description, numerous details are discussed to provide a more thorough explanation of the examples of the present disclosure. It will be apparent to one skilled in the art, however, that examples of the present disclosure may be practiced without these specific details. In other instances, well-known structures and devices are shown in block diagram form, rather than in detail, in order to avoid obscuring examples of the present disclosure.

Note that in the corresponding drawings of the examples, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary examples to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e., scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the examples of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Some implementations provide technology for selectively blocking and unblocking various predictors. Conventionally, multiple core processors/systems may employ some form of prediction technology. Making effective predictions for processors has substantially increased in complexity over previous processor generations. Advances according to Moore's law have resulted in processors being able to host significantly more complex functionality integrated on a single die. This includes significant increases in core count, cache sizes, memory channels, and external interfaces (e.g., chip-to-chip coherent links and I/O links) as well as significantly more advanced reliability, security, and power management algorithms. This increase in microarchitectural complexity has not been matched with corresponding improvements in prediction technology. For example, some prediction technology may cause security problems in some scenarios.

Moreover, given transitions towards a full System-On-Chip (SoC) development model for processors (e.g., server processors), the ability to support a larger number of SoCs (including many product derivatives) with improved security is important. Some implementations may address or overcome one or more of the foregoing problems.

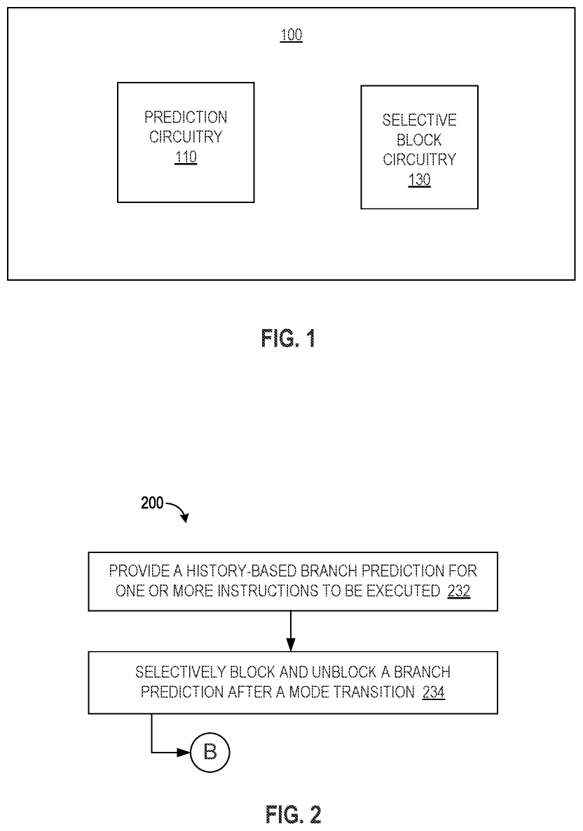

FIG. 1 is an example of an apparatus 100 comprising a first circuitry 110 (e.g., prediction circuitry) to provide a history-based prediction, and second circuitry 130 (e.g., selective block circuitry) coupled to the first circuitry 110 to selectively block and unblock a prediction from the first circuitry after a mode transition. Non-limiting examples of the first circuitry 110 may correspond to any of the various predictors used in a processor (e.g., branch predictors such as indirect predictors, conditional predictors, etc.). In some examples, the first circuitry 110 may be further configured to maintain a prediction table, and the second circuitry 130 may be further configured to selectively block and unblock a prediction from the prediction table based on a number of branches that represent a history utilized by the prediction table, and/or to selectively block and unblock an update to the prediction table based on a number of branches that represent a history utilized by the prediction table.

In some examples, the second circuitry 130 may also be configured to initially block the prediction from the first circuitry 110 in response to the mode transition if a transitioned-to mode is a more privileged mode as compared to a transitioned-from mode. For example, the first circuitry 110 may be further configured to maintain a prediction table and a history length of the prediction table, and the second circuitry 130 may be further configured to continue to block the prediction from the prediction table after the mode transition to the more privileged mode based on the history length of the prediction table, and to unblock the prediction from the prediction table in the more privileged mode after a number of branches equal to the history length have retired. In some examples, the prediction table may correspond to an indirect prediction table. In some examples, the second circuitry 130 may be further configured to maintain a count of taken branches after the mode transition, and selectively block and unblock the prediction from the first circuitry 110 based at least in part on the count of taken branches after the mode transition.

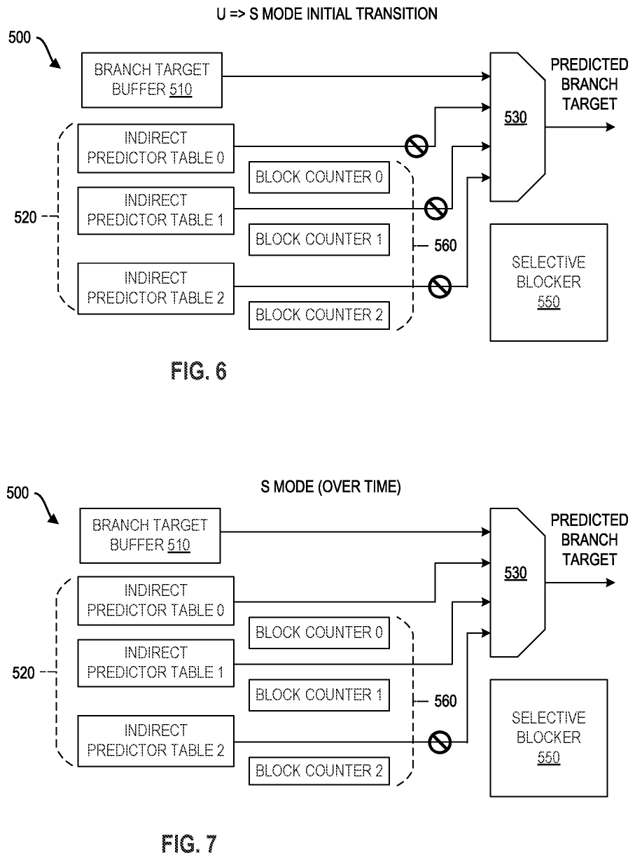

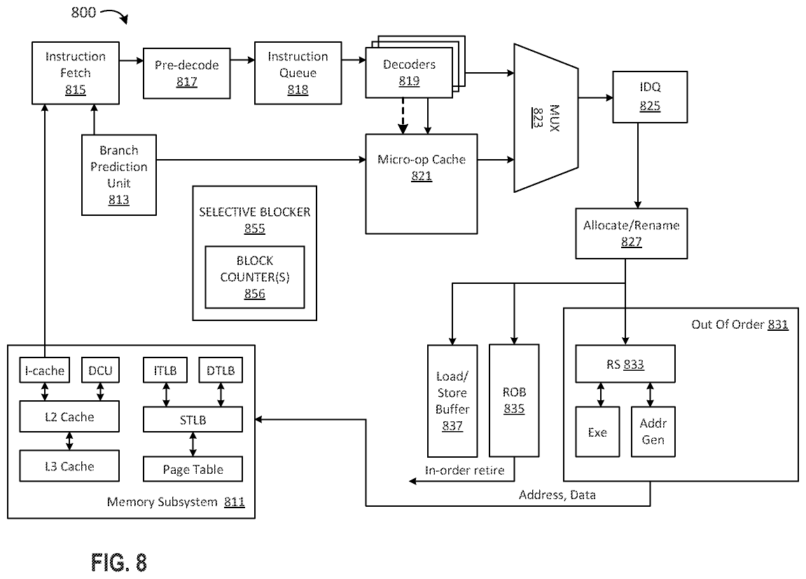

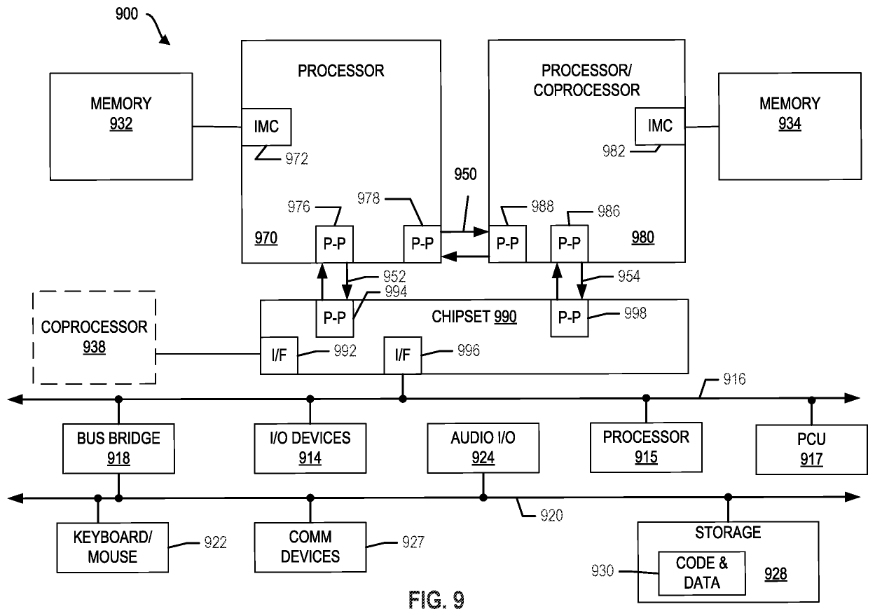

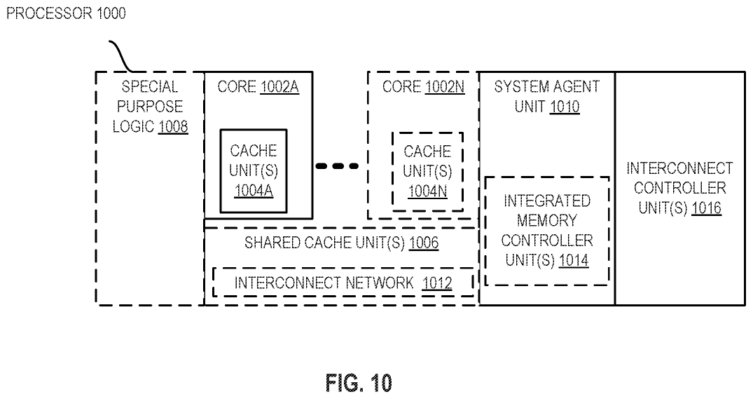

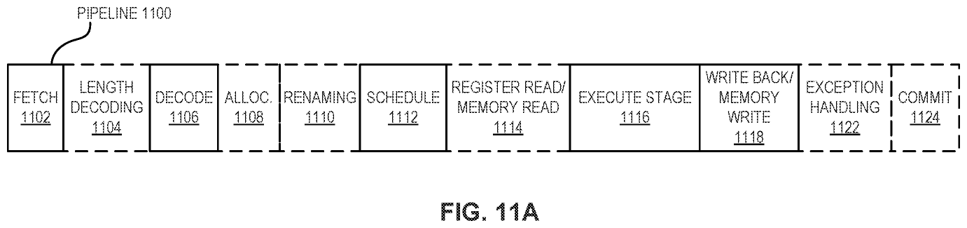

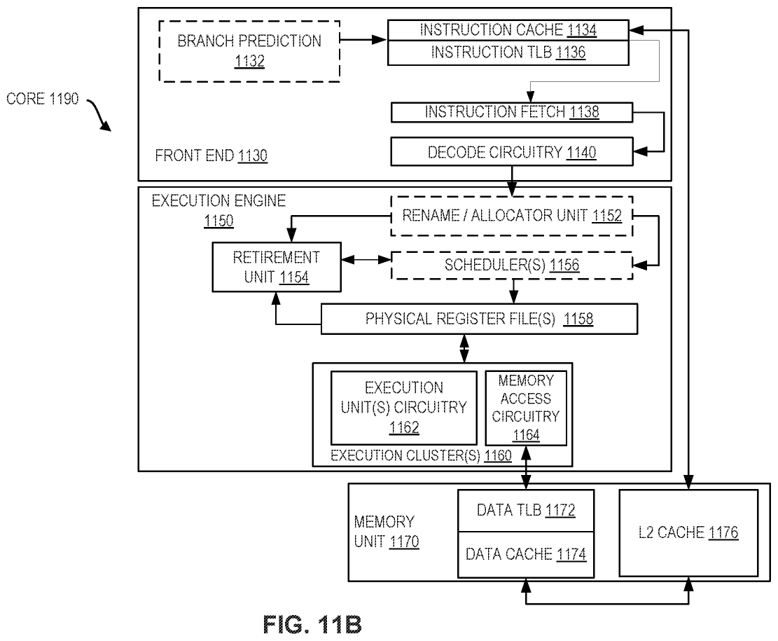

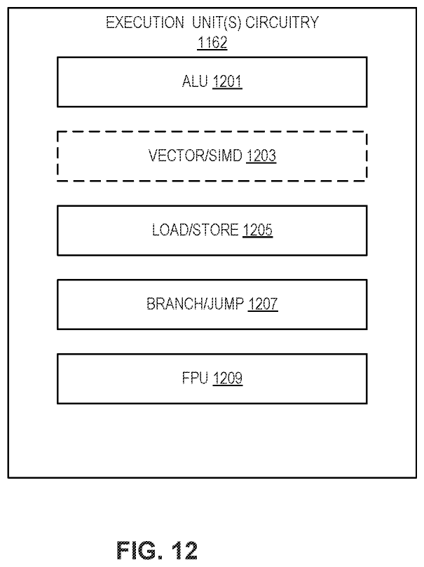

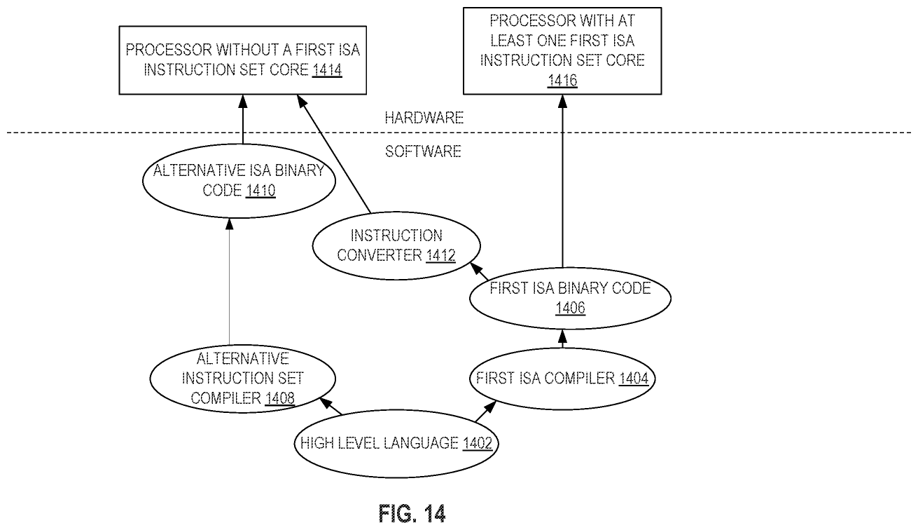

For example, the circuitry 130 may be incorporated in any of the processors/systems described herein. In particular, the circuitry 130 may be integrated with the processor 800 (FIG. 8), the processor 900, the processor 970, the processor 915, the coprocessor 938, the processor/coprocessor 980 (FIG. 9), the processor 1000 (FIG. 10), the core 1190 (FIG. 11B), the execution units 1162 (FIGS. 11B and 12), and the processor 1416 (FIG. 14). In some examples, the circuitry 130 may be implemented by the selective blocker 550 (FIGS. 5 to 7), the selective blocker 855 (FIG. 8), and the front-end circuitry 1130.

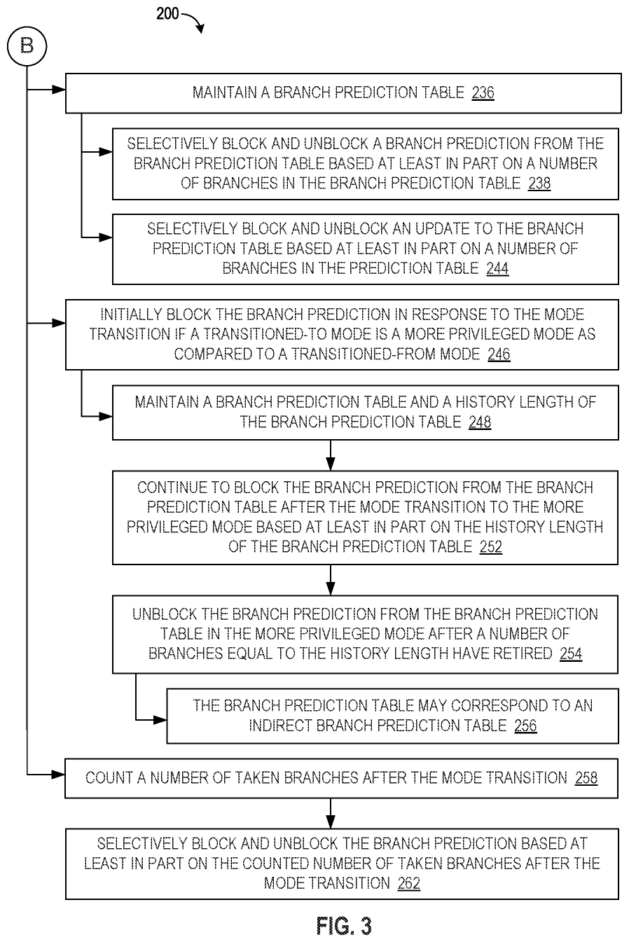

FIGS. 2 to 3 show an example of a method 200 comprising providing a history-based branch prediction for one or more instructions to be executed at 232, and selectively blocking and unblocking a branch prediction after a mode transition at 234. Some examples of the method 200 may further include maintaining a branch prediction table at 236; selectively blocking and unblocking a branch prediction from the branch prediction table based at least in part on a number of branches in the branch prediction table at 238, and/or selectively blocking and unblocking an update to the branch prediction table based at least in part on a number of branches in the prediction table at 244.

In some examples, the method 200 may further include initially blocking the branch prediction in response to the mode transition if a transitioned-to mode is a more privileged mode as compared to a transitioned-from mode at 246. For example, the method 200 may also include maintaining a branch prediction table and a history length of the branch prediction table at 248, continuing to block the branch prediction from the branch prediction table after the mode transition to the more privileged mode based at least in part on the history length of the branch prediction table at 252, and unblocking the branch prediction from the branch prediction table in the more privileged mode after a number of branches equal to the history length have retired at 254. In some examples, the branch prediction table may correspond to an indirect branch prediction table at 256. Some examples of the method 200 may further include counting a number of taken branches after the mode transition at 258, and selectively blocking and unblocking the branch prediction based at least in part on the counted number of taken branches after the mode transition at 262.

For example, the method 200 may be performed by any of the processors/systems described herein. In particular, the method 200 may be performed by the processor 800 (FIG. 8), the processor 900, the processor 970, the processor 915, the coprocessor 938, the processor/coprocessor 980 (FIG. 9), the processor 1000 (FIG. 10), the core 1190 (FIG. 11B), the execution units 1162 (FIGS. 11B and 12), and the processor 1416 (FIG. 14). In some examples, one or more aspects of the method 200 may be performed by the selective blocker 550 (FIGS. 5 to 7), the selective blocker 855 (FIG. 8), and the front-end circuitry 1130.

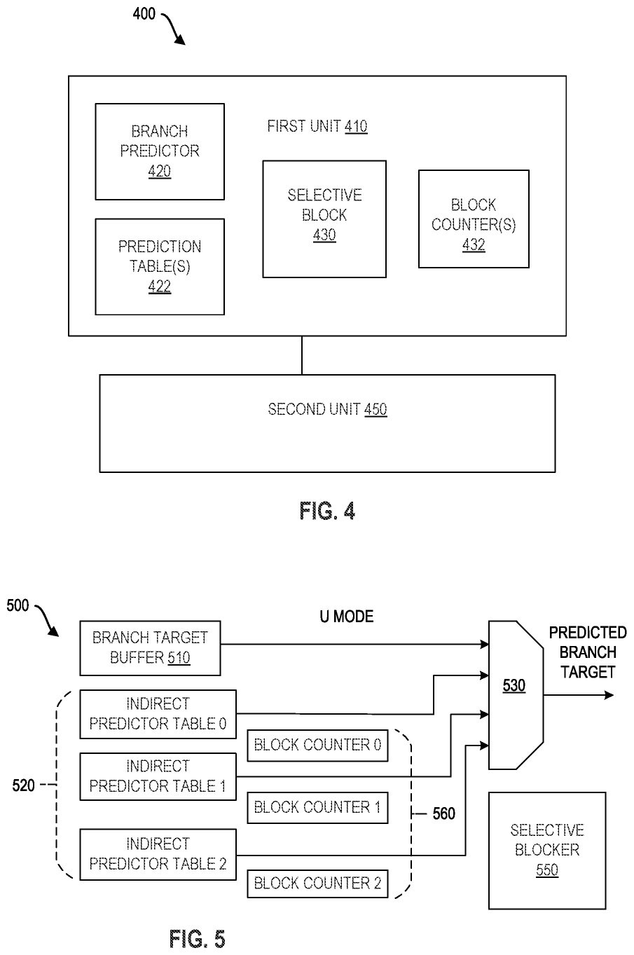

FIG. 4 is an example of an apparatus 400 comprising a first unit 410 to decode one or more instructions, and a second unit 450 coupled to the first unit 410 to execute the one or more decoded instructions. In some examples, the first unit 410 may include first circuitry 420 (e.g., a branch predictor) to provide a branch prediction based on one or more prediction tables 422, and second circuitry 430 (e.g., selective block circuitry) coupled to the first circuitry 420 to selectively block and unblock a branch prediction from one or more of the one or more prediction tables 422 after a transition from a first mode to a second mode. In some examples, the second circuitry 430 may further comprise one or more counters 432 (e.g., block counters) respectively associated with the one or more prediction tables 422 to count a number of taken branches encountered after the transition from the first mode to the second mode. In some examples, the second circuitry 430 may be further configured to selectively block and unblock the branch prediction from one or more of the one or more prediction tables 422 based at least in part on respective values of the one or more counters 432 and respective lengths of the one or more prediction tables 422.

In some examples, the second circuitry 430 may be configured to reset the one or more counters 432 to zero in response to the transition from the first mode to the second mode, increment an associated counter of the one or more counters 432 in response to any taken branch, and to force a miss for any of the one or more prediction tables 422 that have a length that is less than or equal to respective associated values of the one or more counters 432. The second circuitry 430 may also be configured to block one or more of an update and allocation for any of the one or more prediction tables 422 that have a length that is less than or equal to respective associated values of the one or more counters 432. In some examples, the first unit 410 may correspond to a front-end unit and the second unit 450 may correspond to a back-end unit.

For example, the first unit 410 (e.g., including the first circuitry 420, the prediction table(s) 422, the second circuitry 430, and/or the counter 432), and/or the second unit 450 may be incorporated in any of the processors/systems described herein. In particular, the first unit 410 and the second unit 450 may be integrated with the processor 800 (FIG. 8), the processor 900, the processor 970, the processor 915, the coprocessor 938, the processor/coprocessor 980 (FIG. 9), the processor 1000 (FIG. 10), the core 1190 (FIG. 11B), the execution units 1162 (FIGS. 11B and 12), and the processor 1416 (FIG. 14). In some examples, the first unit 410 may include one or more of the front-end/decode circuits from FIG. 8. In some examples, the first unit 410 may be implemented by the front-end unit circuitry 1130 (FIG. 11). In some examples, the second unit 450 may include one or more of the back-end/execution circuits from FIG. 8. In some examples, the second unit 450 may be implemented by the back-end execution engine 1150 (FIG. 11).

Some examples provide technology for selective disabling of branch history-based indirect branch predictors on mode transitions. A problem is that a side-channel security issue may attempt to control a branch history in a less-privileged mode to affect indirect branch prediction in a more-privileged mode, resulting in the possible leaking of sensitive information through the side channel One technique to disallow control of the branch history between different privilege modes may include disabling the history-based indirect branch predictors entirely, either when in the more-privileged mode or altogether. Another technique may include disabling all branch prediction of indirect branches when in a privileged mode. Another technique may include clearing the branch history on mode transitions. A problem is that techniques that disable the indirect branch predictors may involve processor performance penalties because all ability is removed to speculatively execute past an indirect branch when the processor is in a privileged mode. Another problem is that clearing the branch history may also cause additional mispredictions to occur when running less privileged code following the mode transition.

Some examples may address or overcome one or more of the foregoing problems. Some examples may reduce, inhibit, or remove the ability to control the branch history of the more-privileged mode in a manner that reduces or minimizes performance losses.

In some processors, indirect predictor tables may be structured with tiered history lengths ranging from short to long branch histories. Some examples may be applied for a wide variety of prediction techniques based on a record of previous branches. For example, a branch history used for the indirect branch prediction may contain information such as instruction address and target address of taken or non-taken branches prior to the branch being predicted. This history can then be compressed to form the index and tag required to look up an entry in the indirect predictor tables. The branch history is used in such a way that a portion used to access each indirect table is related to a set number of branches prior to the branch being predicted. Some examples may selectively block predictions from and updates to each indirect predictor table based on the number of branches needed to create the history used by each table. In some examples, the indirect predictor tables are blocked following a transition to a more-privileged mode. Subsequently, after a number of branches equal to the history length have retired, some examples then unblock the indirect predictor table while still in that mode. Advantageously, some examples may improve performance (e.g., as compared to completely disabling branch prediction or clearing the branch history) by allowing increasingly accurate indirect branch predictions to be made the longer a program remains in the higher privileged mode. Some examples do not affect the branch history register directly and therefore may not negatively impact branch predictions following the transition out of the more-privileged mode. In another advantage, some examples may further maintain security of the indirection branch information.

Some examples provide technology to selectively block the use of history-based indirect predictors following a mode transition, where the length of the blocking is related to the history length used by each table.

In an example scenario, a privileged mode may have static indirect branches at addresses A, B, etc. Branch A may be expected to only go to targets A′, A″, A*, while branch B may be expected to only go to targets B′, B″, B*. For example, the processor doesn't expect branch A to go to one of B's targets B′, B″, B*. If the code up to and including branch A executes speculatively with the code at one of B's targets, the code may create a return-oriented programming (ROP)-like code gadget that may reveal sensitive supervisor information or other secure information. A problem is that on transitions to a more secure mode, the initial privileged indirect branches are predicted with branch history information that came from the previous mode code before the transition. Malicious code running in user mode, for example, may attempt to execute branches to force the history to a particular value and then make a system call to the supervisor code. By forcing the history to a particular value, the malicious code may attempt to trick the secure mode into forcing branch A to go to one of B's targets, which may create the code gadget that may reveal sensitive information to the malicious code.

As noted above, an approach to the foregoing scenario may involve entirely disabling the indirect predictors in the secure mode, with a potentially large performance cost because with the indirect predictors disabled, in addition to stopping the incorrect predictions to the wrong targets, Branch A cannot predict its correct targets A′, A″, A*.

Some examples may provide a counter (e.g., sometimes referred to herein as a block counter) that counts the number of taken branches encountered since the last mode transition. The following example is applied in relation to a usermode (U) to supervisor (S) mode transition, where the S mode is the more secure, privileged mode. Other examples may be applied to other mode transitions, including S mode to U mode, guest mode to host mode, or other secure mode transitions (e.g., or other kernel modes, ring levels, etc.). Other examples may also be applied to any branch history-based predictors (e.g., in addition to or alternative to indirect predictors) including, for example, conditional branch predictors.

In this example, a U2S block counter counts the number of taken branches encountered since the last U mode to S mode transition. Whenever a U mode to S mode transition occurs, the U2S block counter is reset to zero (0). Whenever a branch is taken, the U2S block counter is incremented. For example, if a value of the U2S block counter is four (4) and the processor is in the S mode, the value of the U2S block counter indicates that the S mode has seen four branches. In this example, the history contains only S mode information for the most recent four branches.

An indirect predictor may have many tables, each of which may be indexed and tagged with a branch history of length N taken branches, where N may be different for each table. If, for a given table, the U2S block counter is less than that table's length N, then some examples consider that table as ineligible to use because that table is indexed and tagged with information from the U mode. Accordingly, at prediction time some examples force a table to miss if the branch history length N of the table is less than or equal to the value of the U2S block counter. Similarly, at update time, some examples don't update a table or allocate a table if the branch history length N of the table is less than or equal to the value of the U2S block counter.

On a U mode to S mode transition, some examples may not initially use any of the indirect predictor tables because the branch history does not have any S mode information therein. As branches are encountered in S mode, the branches are added to the history. At some point, enough S mode information may be added in the history to re-enable the indirect predictor table with the shortest history length. Subsequently, after the indirect predictor table with the shortest history length is re-enabled, enough S mode information may be added to the history to re-enable another indirect predictor table with the second shortest history, and so on.

On a S mode to U mode transition, in some examples, all the indirect predictors may be immediately enabled, even if a threshold of taken branches for an indirect predictor was not reached while in S mode Immediately enabling all the indirect predictors may reduce or minimize a performance loss by ensuring U mode predictions can use the predictors. The indirect predictors may also be able to use branch history from within S mode and prior to the S mode transition, which may allow for more or maximum prediction accuracy.

FIGS. 5 to 7 show an example of a system 500 that includes a branch target buffer 510 and three indirect predictor tables 520 (e.g., Indirect Table 0 through 2) coupled to an indirect branch predictor 530 that outputs a predicted branch target. The system 500 further includes a selective blocker 550 configured to selectively block and unblock predictions from the tables 520 based on values of block counters 560 (e.g., block counter 0 through 2) respectively associated with the tables 520. FIG. 5 shows how predictions are not blocked in the U mode. FIG. 6 shows how, following a transition from the U mode to a S mode, all indirect predictor tables are initially blocked (e.g., with all of the block counters 560 reset to a value of 0). FIG. 7 shows how, after the retirement of taken branches equal to or greater than the history length used by indirect tables 0 and 1, only indirect table 2 is blocked (e.g., block counter 0>length N of Indirect Table 0, and block counter 1>length M of Indirect Table 1). Advantageously, as compared to clearing the branch history or disabling the indirect predictor tables entirely, some examples may improve performance while providing a security benefit of inhibiting or preventing side channel attacks through control of the branch history.

With reference to FIG. 8, an example of an out-of-order (OOO) processor core 800 includes a memory subsystem 811, a branch prediction unit (BPU) 813, an instruction fetch circuit 815, a pre-decode circuit 817, an instruction queue 818, decoders 819, a micro-op cache 821, a mux 823, an instruction decode queue (IDQ) 825, an allocate/rename circuit 827, an out-of-order core 831, a reservation station (RS) 833, a re-order buffer (ROB) 835, and a load/store buffer 837, coupled as shown. The memory subsystem 811 includes a level-1(L1) instruction cache (I-cache), a L1 data cache (DCU), a L2 cache, a L3 cache, an instruction translation lookaside buffer (ITLB), a data translation lookaside buffer (DTLB), a shared translation lookaside buffer (STLB), and a page table, connected as shown. The OOO core 831 includes the RS 833, an Exe circuit, and an address generation circuit, coupled as shown. In this example, the core 800 may further include selective blocker circuitry 855 (e.g., that includes one or more block counter(s) 856), and other circuitry as described herein, to provide automatic fusion of arithmetic in-flight instructions.

For example, the selective blocker 855 may be coupled to the various components of the OOO processor 800 and microcode/firmware to selectively block/unblock predictions from various predictors of the processor 800. In some examples, the BPU 813 may include various branch predictors to provide branch predictions based on a set of prediction tables. The selective blocker 855 may be coupled to the various predictors/tables to selectively block and unblock a branch prediction from the prediction tables after a transition from a U mode to a S mode. In some examples, the selective blocker 855 may utilize the block counters 856 (e.g., that are respectively associated with the prediction tables) to count a number of taken branches encountered after the transition from the U mode to the S mode. In some examples, the selective blocker 855 may be further configured to selectively block and unblock the branch prediction from the prediction tables based at least in part on respective values of the block counters 856 and respective lengths N of the prediction tables.

In some examples, the selective blocker 855 may be configured to reset the block counters 856 to zero in response to the transition from the U mode to the S mode, increment an particular counter of the block counters 856 in response to any taken branch (e.g., where the particular counter is associated with the prediction table for the taken branch), and to force a miss for any of the prediction tables that have a length N that is less than or equal to respective associated values of the block counters 856. The selective blocker 855 may also be configured to block one or more of an update and allocation for any of the prediction tables that have a length N that is less than or equal to respective associated values of the block counters 856.

Exemplary Computer Architectures.

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 9 illustrates an exemplary system. Multiprocessor system 900 is a point-to-point interconnect system and includes a plurality of processors including a first processor 970 and a second processor 980 coupled via a point-to-point interconnect 950. In some examples, the first processor 970 and the second processor 980 are homogeneous. In some examples, first processor 970 and the second processor 980 are heterogenous. Though the exemplary system 900 is shown to have two processors, the system may have three or more processors, or may be a single processor system.

Processors 970 and 980 are shown including integrated memory controller (IMC) circuitry 972 and 982, respectively. Processor 970 also includes as part of its interconnect controller point-to-point (P-P) interfaces 976 and 978; similarly, second processor 980 includes P-P interfaces 986 and 988. Processors 970, 980 may exchange information via the point-to-point (P-P) interconnect 950 using P-P interface circuits 978, 988. IMCs 972 and 982 couple the processors 970, 980 to respective memories, namely a memory 932 and a memory 934, which may be portions of main memory locally attached to the respective processors.

Processors 970, 980 may each exchange information with a chipset 990 via individual P-P interconnects 952, 954 using point to point interface circuits 976, 994, 986, 998. Chipset 990 may optionally exchange information with a coprocessor 938 via an interface 992. In some examples, the coprocessor 938 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 970, 980 or outside of both processors, yet connected with the processors via P-P interconnect, such that either or both processors' local cache information may be stored in the shared cache if a processor is placed into a low power mode.

Chipset 990 may be coupled to a first interconnect 916 via an interface 996. In some examples, first interconnect 916 may be a Peripheral Component Interconnect (PCI) interconnect, or an interconnect such as a PCI Express interconnect or another I/O interconnect. In some examples, one of the interconnects couples to a power control unit (PCU) 917, which may include circuitry, software, and/or firmware to perform power management operations with regard to the processors 970, 980 and/or co-processor 938. PCU 917 provides control information to a voltage regulator (not shown) to cause the voltage regulator to generate the appropriate regulated voltage. PCU 917 also provides control information to control the operating voltage generated. In various examples, PCU 917 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 917 is illustrated as being present as logic separate from the processor 970 and/or processor 980. In other cases, PCU 917 may execute on a given one or more of cores (not shown) of processor 970 or 980. In some cases, PCU 917 may be implemented as a microcontroller (dedicated or general-purpose) or other control logic configured to execute its own dedicated power management code, sometimes referred to as P-code. In yet other examples, power management operations to be performed by PCU 917 may be implemented externally to a processor, such as by way of a separate power management integrated circuit (PMIC) or another component external to the processor. In yet other examples, power management operations to be performed by PCU 917 may be implemented within BIOS or other system software.

Various I/O devices 914 may be coupled to first interconnect 916, along with a bus bridge 918 which couples first interconnect 916 to a second interconnect 920. In some examples, one or more additional processor(s) 915, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 916. In some examples, second interconnect 920 may be a low pin count (LPC) interconnect. Various devices may be coupled to second interconnect 920 including, for example, a keyboard and/or mouse 922, communication devices 927 and a storage circuitry 928. Storage circuitry 928 may be one or more non-transitory machine-readable storage media as described below, such as a disk drive or other mass storage device which may include instructions/code and data 930 in some examples. Further, an audio I/O 924 may be coupled to second interconnect 920. Note that other architectures than the point-to-point architecture described above are possible. For example, instead of the point-to-point architecture, a system such as multiprocessor system 900 may implement a multi-drop interconnect or other such architecture.

Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 10 illustrates a block diagram of an example processor 1000 that may have more than one core and an integrated memory controller. The solid lined boxes illustrate a processor 1000 with a single core 1002A, a system agent unit circuitry 1010, a set of one or more interconnect controller unit(s) circuitry 1016, while the optional addition of the dashed lined boxes illustrates an alternative processor 1000 with multiple cores 1002(A)-(N), a set of one or more integrated memory controller unit(s) circuitry 1014 in the system agent unit circuitry 1010, and special purpose logic 1008, as well as a set of one or more interconnect controller units circuitry 1016. Note that the processor 1000 may be one of the processors 970 or 980, or co-processor 938 or 915 of FIG. 9.

Thus, different implementations of the processor 1000 may include: 1) a CPU with the special purpose logic 1008 being integrated graphics and/or scientific (throughput) logic (which may include one or more cores, not shown), and the cores 1002(A)-(N) being one or more general purpose cores (e.g., general purpose in-order cores, general purpose out-of-order cores, or a combination of the two); 2) a coprocessor with the cores 1002(A)-(N) being a large number of special purpose cores intended primarily for graphics and/or scientific (throughput); and 3) a coprocessor with the cores 1002(A)-(N) being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1004(A)-(N) within the cores 1002(A)-(N), a set of one or more shared cache unit(s) circuitry 1006, and external memory (not shown) coupled to the set of integrated memory controller unit(s) circuitry 1014. The set of one or more shared cache unit(s) circuitry 1006 may include one or more mid-level caches, such as level 2 (L2), level 3 (L3), level 4 (L4), or other levels of cache, such as a last level cache (LLC), and/or combinations thereof. While in some examples ring-based interconnect network circuitry 1012 interconnects the special purpose logic 1008 (e.g., integrated graphics logic), the set of shared cache unit(s) circuitry 1006, and the system agent unit circuitry 1010, alternative examples use any number of well-known techniques for interconnecting such units. In some examples, coherency is maintained between one or more of the shared cache unit(s) circuitry 1006 and cores 1002(A)-(N).

In some examples, one or more of the cores 1002(A)-(N) are capable of multi-threading. The system agent unit circuitry 1010 includes those components coordinating and operating cores 1002(A)-(N). The system agent unit circuitry 1010 may include, for example, power control unit (PCU) circuitry and/or display unit circuitry (not shown). The PCU may be or may include logic and components needed for regulating the power state of the cores 1002(A)-(N) and/or the special purpose logic 1008 (e.g., integrated graphics logic). The display unit circuitry is for driving one or more externally connected displays.

The cores 1002(A)-(N) may be homogenous in terms of instruction set architecture (ISA). Alternatively, the cores 1002(A)-(N) may be heterogeneous in terms of ISA; that is, a subset of the cores 1002(A)-(N) may be capable of executing an ISA, while other cores may be capable of executing only a subset of that ISA or another ISA.

Exemplary Core Architectures—In-order and out-of-order core block diagram.

FIG. 11A is a block diagram illustrating both an exemplary in-order pipeline and an exemplary register renaming, out-of-order issue/execution pipeline according to examples. FIG. 11B is a block diagram illustrating both an exemplary example of an in-order architecture core and an exemplary register renaming, out-of-order issue/execution architecture core to be included in a processor according to examples. The solid lined boxes in FIGS. 11A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11A, a processor pipeline 1100 includes a fetch stage 1102, an optional length decoding stage 1104, a decode stage 1106, an optional allocation (Alloc) stage 1108, an optional renaming stage 1110, a schedule (also known as a dispatch or issue) stage 1112, an optional register read/memory read stage 1114, an execute stage 1116, a write back/memory write stage 1118, an optional exception handling stage 1122, and an optional commit stage 1124. One or more operations can be performed in each of these processor pipeline stages. For example, during the fetch stage 1102, one or more instructions are fetched from instruction memory, and during the decode stage 1106, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1106 and the register read/memory read stage 1114 may be combined into one pipeline stage. In one example, during the execute stage 1116, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 11B may implement the pipeline 1100 as follows: 1) the instruction fetch circuitry 1138 performs the fetch and length decoding stages 1102 and 1104; 2) the decode circuitry 1140 performs the decode stage 1106; 3) the rename/allocator unit circuitry 1152 performs the allocation stage 1108 and renaming stage 1110; 4) the scheduler(s) circuitry 1156 performs the schedule stage 1112; 5) the physical register file(s) circuitry 1158 and the memory unit circuitry 1170 perform the register read/memory read stage 1114; the execution cluster(s) 1160 perform the execute stage 1116; 6) the memory unit circuitry 1170 and the physical register file(s) circuitry 1158 perform the write back/memory write stage 1118; 7) various circuitry may be involved in the exception handling stage 1122; and 8) the retirement unit circuitry 1154 and the physical register file(s) circuitry 1158 perform the commit stage 1124.

FIG. 11B shows a processor core 1190 including front-end unit circuitry 1130 coupled to an execution engine unit circuitry 1150, and both are coupled to a memory unit circuitry 1170. The core 1190 may be a reduced instruction set architecture computing (RISC) core, a complex instruction set architecture computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front-end unit circuitry 1130 may include branch prediction circuitry 1132 coupled to an instruction cache circuitry 1134, which is coupled to an instruction translation lookaside buffer (TLB) 1136, which is coupled to instruction fetch circuitry 1138, which is coupled to decode circuitry 1140. In one example, the instruction cache circuitry 1134 is included in the memory unit circuitry 1170 rather than the front-end unit circuitry 1130. The decode circuitry 1140 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1140 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1140 may be implemented using various different mechanisms. Examples of suitable mechanisms include, but are not limited to, look-up tables, hardware implementations, programmable logic arrays (PLAs), microcode read only memories (ROMs), etc. In one example, the core 1190 includes a microcode ROM (not shown) or other medium that stores microcode for certain macroinstructions (e.g., in decode circuitry 1140 or otherwise within the front-end unit circuitry 1130). In one example, the decode circuitry 1140 includes a micro-operation (micro-op) or operation cache (not shown) to hold/cache decoded operations, micro-tags, or micro-operations generated during the decode or other stages of the processor pipeline 1100. The decode circuitry 1140 may be coupled to rename/allocator unit circuitry 1152 in the execution engine circuitry 1150.

The execution engine circuitry 1150 includes the rename/allocator unit circuitry 1152 coupled to a retirement unit circuitry 1154 and a set of one or more scheduler(s) circuitry 1156. The scheduler(s) circuitry 1156 represents any number of different schedulers, including reservations stations, central instruction window, etc. In some examples, the scheduler(s) circuitry 1156 can include arithmetic logic unit (ALU) scheduler/scheduling circuitry, ALU queues, arithmetic generation unit (AGU) scheduler/scheduling circuitry, AGU queues, etc. The scheduler(s) circuitry 1156 is coupled to the physical register file(s) circuitry 1158. Each of the physical register file(s) circuitry 1158 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1158 includes vector registers unit circuitry, writemask registers unit circuitry, and scalar register unit circuitry. These register units may provide architectural vector registers, vector mask registers, general-purpose registers, etc. The physical register file(s) circuitry 1158 is coupled to the retirement unit circuitry 1154 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1154 and the physical register file(s) circuitry 1158 are coupled to the execution cluster(s) 1160. The execution cluster(s) 1160 includes a set of one or more execution unit(s) circuitry 1162 and a set of one or more memory access circuitry 1164. The execution unit(s) circuitry 1162 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1156, physical register file(s) circuitry 1158, and execution cluster(s) 1160 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1164). It should also be understood that where separate pipelines are used, one or more of these pipelines may be out-of-order issue/execution and the rest in-order.

In some examples, the execution engine unit circuitry 1150 may perform load store unit (LSU) address/data pipelining to an Advanced Microcontroller Bus (AMB) interface (not shown), and address phase and writeback, data phase load, store, and branches.

The set of memory access circuitry 1164 is coupled to the memory unit circuitry 1170, which includes data TLB circuitry 1172 coupled to a data cache circuitry 1174 coupled to a level 2 (L2) cache circuitry 1176. In one exemplary example, the memory access circuitry 1164 may include a load unit circuitry, a store address unit circuit, and a store data unit circuitry, each of which is coupled to the data TLB circuitry 1172 in the memory unit circuitry 1170. The instruction cache circuitry 1134 is further coupled to the level 2 (L2) cache circuitry 1176 in the memory unit circuitry 1170. In one example, the instruction cache 1134 and the data cache 1174 are combined into a single instruction and data cache (not shown) in L2 cache circuitry 1176, a level 3 (L3) cache circuitry (not shown), and/or main memory. The L2 cache circuitry 1176 is coupled to one or more other levels of cache and eventually to a main memory.

The core 1190 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1190 includes logic to support a packed data instruction set architecture extension (e.g., AVX1, AVX2), thereby allowing the operations used by many multimedia applications to be performed using packed data.

Exemplary Execution Unit(s) Circuitry.

FIG. 12 illustrates examples of execution unit(s) circuitry, such as execution unit(s) circuitry 1162 of FIG. 11B. As illustrated, execution unit(s) circuitry 1162 may include one or more ALU circuits 1201, optional vector/single instruction multiple data (SIMD) circuits 1203, load/store circuits 1205, branch/jump circuits 1207, and/or Floating-point unit (FPU) circuits 1209. ALU circuits 1201 perform integer arithmetic and/or Boolean operations. Vector/SIMD circuits 1203 perform vector/SIMD operations on packed data (such as SIMD/vector registers). Load/store circuits 1205 execute load and store instructions to load data from memory into registers or store from registers to memory. Load/store circuits 1205 may also generate addresses. Branch/jump circuits 1207 cause a branch or jump to a memory address depending on the instruction. FPU circuits 1209 perform floating-point arithmetic. The width of the execution unit(s) circuitry 1162 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Exemplary Register Architecture

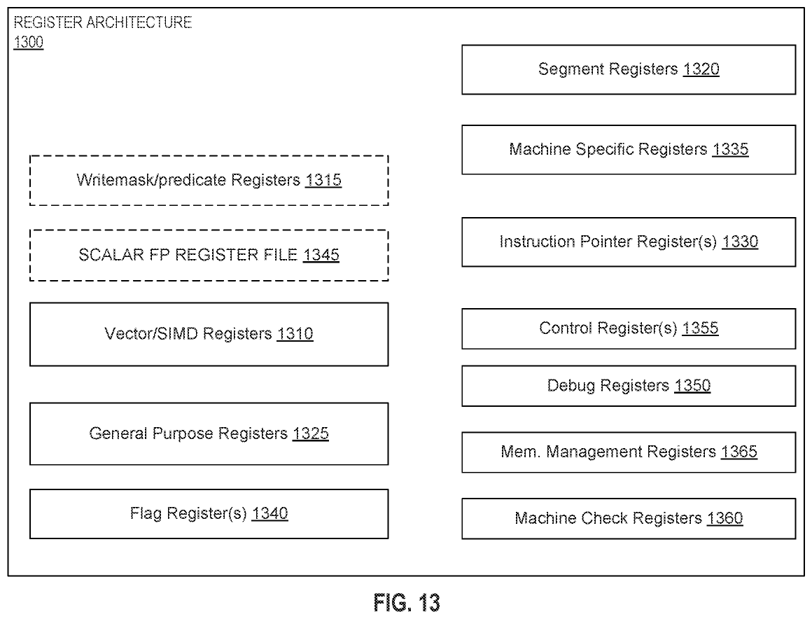

FIG. 13 is a block diagram of a register architecture 1300 according to some examples. As illustrated, the register architecture 1300 includes vector/SIMD registers 1310 that vary from 128-bit to 1,024 bits width. In some examples, the vector/SIMD registers 1310 are physically 512-bits and, depending upon the mapping, only some of the lower bits are used. For example, in some examples, the vector/SIMD registers 1310 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1300 includes writemask/predicate registers 1315. For example, in some examples, there are 8 writemask/predicate registers (sometimes called k0 through k7) that are each 16-bit, 32-bit, 64-bit, or 128-bit in size. Writemask/predicate registers 1315 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1315 corresponds to a data element position of the destination. In other examples, the writemask/predicate registers 1315 are scalable and consists of a set number of enable bits for a given vector element (e.g., 8 enable bits per 64-bit vector element).

The register architecture 1300 includes a plurality of general-purpose registers 1325. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1300 includes scalar floating-point (FP) register 1345 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1340 (e.g., EFLAGS, RFLAGS, etc.) store status and control information for arithmetic, compare, and system operations. For example, the one or more flag registers 1340 may store condition code information such as carry, parity, auxiliary carry, zero, sign, and overflow. In some examples, the one or more flag registers 1340 are called program status and control registers.

Segment registers 1320 contain segment points for use in accessing memory. In some examples, these registers are referenced by the names CS, DS, SS, ES, FS, and GS.

Machine specific registers (MSRs) 1335 control and report on processor performance. Most MSRs 1335 handle system-related functions and are not accessible to an application program. Machine check registers 1360 consist of control, status, and error reporting MSRs that are used to detect and report on hardware errors.

One or more instruction pointer register(s) 1330 store an instruction pointer value. Control register(s) 1355 (e.g., CR0-CR4) determine the operating mode of a processor (e.g., processor 970, 980, 938, 915, and/or 1000) and the characteristics of a currently executing task. Debug registers 1350 control and allow for the monitoring of a processor or core's debugging operations.

Memory (mem) management registers 1365 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1300 may, for example, be used in a register file/memory, or physical register file(s) circuitry 1158.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 14 illustrates a block diagram contrasting the use of a software instruction converter to convert binary instructions in a source instruction set architecture to binary instructions in a target instruction set architecture according to examples. In the illustrated example, the instruction converter is a software instruction converter, although alternatively the instruction converter may be implemented in software, firmware, hardware, or various combinations thereof. FIG. 14 shows a program in a high-level language 1402 may be compiled using a first ISA compiler 1404 to generate first ISA binary code 1406 that may be natively executed by a processor with at least one first instruction set architecture core 1416. The processor with at least one first ISA instruction set architecture core 1416 represents any processor that can perform substantially the same functions as an Intel® processor with at least one first ISA instruction set architecture core by compatibly executing or otherwise processing (1) a substantial portion of the instruction set architecture of the first ISA instruction set architecture core or (2) object code versions of applications or other software targeted to run on an Intel processor with at least one first ISA instruction set architecture core, in order to achieve substantially the same result as a processor with at least one first ISA instruction set architecture core. The first ISA compiler 1404 represents a compiler that is operable to generate first ISA binary code 1406 (e.g., object code) that can, with or without additional linkage processing, be executed on the processor with at least one first ISA instruction set architecture core 1416. Similarly, FIG. 14 shows the program in the high-level language 1402 may be compiled using an alternative instruction set architecture compiler 1408 to generate alternative instruction set architecture binary code 1410 that may be natively executed by a processor without a first ISA instruction set architecture core 1414. The instruction converter 1412 is used to convert the first ISA binary code 1406 into code that may be natively executed by the processor without a first ISA instruction set architecture core 1414. This converted code is not necessarily to be the same as the alternative instruction set architecture binary code 1410; however, the converted code will accomplish the general operation and be made up of instructions from the alternative instruction set architecture. Thus, the instruction converter 1412 represents software, firmware, hardware, or a combination thereof that, through emulation, simulation or any other process, allows a processor or other electronic device that does not have a first ISA instruction set architecture processor or core to execute the first ISA binary code 1406.

Techniques and architectures for selective disable of history-based predictors on mode transitions are described herein. In the above description, for purposes of explanation, numerous specific details are set forth in order to provide a thorough understanding of certain examples. It will be apparent, however, to one skilled in the art that certain examples can be practiced without these specific details. In other instances, structures and devices are shown in block diagram form in order to avoid obscuring the description

Additional Notes and Examples

Example 1 includes an apparatus comprising first circuitry to provide a history-based prediction, and second circuitry coupled to the first circuitry to selectively block and unblock a prediction from the first circuitry after a mode transition.

Example 2 includes the apparatus of Example 1, wherein the first circuitry is further to maintain a prediction table, and wherein the second circuitry is further to selectively block and unblock a prediction from the prediction table based on a number of branches that represent a history utilized by the prediction table.

Example 3 includes the apparatus of any of Examples 1 to 2, wherein the first circuitry is further to maintain a prediction table, and wherein the second circuitry is further to selectively block and unblock an update to the prediction table based on a number of branches that represent a history utilized by the prediction table.

Example 4 includes the apparatus of any of Examples 1 to 3, wherein the second circuitry is further to initially block the prediction from the first circuitry in response to the mode transition if a transitioned-to mode is a more privileged mode as compared to a transitioned-from mode.

Example 5 includes the apparatus of Example 4, wherein the first circuitry is further to maintain a prediction table and a history length of the prediction table, and wherein the second circuitry is further to continue to block the prediction from the prediction table after the mode transition to the more privileged mode based on the history length of the prediction table.

Example 6 includes the apparatus of Example 5, wherein the second circuitry is further to unblock the prediction from the prediction table in the more privileged mode after a number of branches equal to the history length have retired.

Example 7 includes the apparatus of any of Examples 2 to 6, wherein the prediction table corresponds to an indirect prediction table.

Example 8 includes the apparatus of any of Examples 1 to 7, wherein the second circuitry is further to maintain a count of taken branches after the mode transition, and selectively block and unblock the prediction from the first circuitry based at least in part on the count of taken branches after the mode transition.

Example 9 includes a method comprising providing a history-based branch prediction for one or more instructions to be executed, and selectively blocking and unblocking a branch prediction after a mode transition.

Example 10 includes the method of Example 9, further comprising maintaining a branch prediction table, and selectively blocking and unblocking a branch prediction from the branch prediction table based at least in part on a number of branches in the branch prediction table.

Example 11 includes the method of any of Examples 9 to 10, further comprising maintaining a branch prediction table, and selectively blocking and unblocking an update to the branch prediction table based at least in part on a number of branches in the prediction table.

Example 12 includes the method of any of Examples 9 to 10, further comprising initially blocking the branch prediction in response to the mode transition if a transitioned-to mode is a more privileged mode as compared to a transitioned-from mode.

Example 13 includes the method of Example 12, further comprising maintaining a branch prediction table and a history length of the branch prediction table, and continuing to block the branch prediction from the branch prediction table after the mode transition to the more privileged mode based on the history length of the branch prediction table.

Example 14 includes the method of Example 13, further comprising unblocking the branch prediction from the branch prediction table in the more privileged mode after a number of branches equal to the history length have retired.

Example 15 includes the method of any of Examples 10 to 14, wherein the branch prediction table corresponds to an indirect branch prediction table.

Example 16 includes the method of any of Examples 9 to 15, further comprising counting a number of taken branches after the mode transition, and selectively blocking and unblocking the branch prediction based at least in part on the counted number of taken branches after the mode transition.

Example 17 includes an apparatus comprising a first unit to decode one or more instructions, and a second unit coupled to the first unit to execute the one or more decoded instructions, the first unit including first circuitry to provide a branch prediction based on one or more prediction tables, and second circuitry coupled to the first circuitry to selectively block and unblock a branch prediction from one or more of the one or more prediction tables after a transition from a first mode to a second mode.

Example 18 includes the apparatus of Example 17, wherein the second circuitry further comprises one or more counters respectively associated with the one or more prediction tables to count a number of taken branches encountered after the transition from the first mode to the second mode.

Example 19 includes the apparatus of Example 18, wherein the second circuitry is further to selectively block and unblock the branch prediction from one or more of the one or more prediction tables based at least in part on respective values of the one or more counters and respective lengths of the one or more prediction tables.

Example 20 includes the apparatus of any of Examples 18 to 19, wherein the second circuitry is further to reset the one or more counters to zero in response to the transition from the first mode to the second mode.

Example 21 includes the apparatus of Example 20, wherein the second circuitry is further to increment an associated counter of the one or more counters in response to any taken branch.

Example 22 includes the apparatus of Example 21, wherein the second circuitry is further to force a miss for any of the one or more prediction tables that have a length that is less than or equal to respective associated values of the one or more counters.

Example 23 includes the apparatus of any of Examples 21 to 22, wherein the second circuitry is further to block one or more of an update and allocation for any of the one or more prediction tables that have a length that is less than or equal to respective associated values of the one or more counters.

Example 24 includes the apparatus of any of Examples 17 to 23, wherein the first unit corresponds to a front-end unit and the second unit corresponds to a back-end unit.

Example 25 includes a method comprising decoding one or more instructions, providing a branch prediction for the one or more decoded instructions based on one or more prediction tables, selectively blocking and unblocking a branch prediction from one or more of the one or more prediction tables after a transition from a first mode to a second mode, and executing the one or more decoded instructions.

Example 26 includes the method of Example 25, further comprising providing one or more counters to count a number of taken branches encountered after the transition from the first mode to the second mode.

Example 27 includes the method of Example 26, further comprising selectively blocking and unblocking the branch prediction from one or more of the one or more prediction tables based at least in part on respective values of the one or more counters and respective lengths of the one or more prediction tables.

Example 28 includes the method of any of Examples 26 to 27, further comprising resetting the one or more counters to zero in response to the transition from the first mode to the second mode.

Example 29 includes the method of Example 28, further comprising incrementing an associated counter of the one or more counters in response to any taken branch.

Example 30 includes the method of Example 29, further comprising forcing a miss for any of the one or more prediction tables that have a length that is less than or equal to respective associated values of the one or more counters.

Example 31 includes the method of any of Examples 28 to 30, further comprising blocking one or more of an update and allocation for any of the one or more prediction tables that have a length that is less than or equal to respective associated values of the one or more counters.

Example 32 includes at least one non-transitory one machine readable medium comprising a plurality of instructions that, in response to being executed on a computing device, cause the computing device to provide a history-based branch prediction for one or more instructions to be executed, and selectively block and unblock a branch prediction after a mode transition.

Example 33 includes the at least one non-transitory one machine readable medium of Example 32, comprising a plurality of further instructions that, in response to being executed on the computing device, cause the computing device to maintain a branch prediction table, and selectively block and unblock a branch prediction from the branch prediction table based on a number of branches in the branch prediction table.

Example 34 includes the at least one non-transitory one machine readable medium of any of Examples 32 to 33, comprising a plurality of further instructions that, in response to being executed on the computing device, cause the computing device to maintain a branch prediction table, and selectively block and unblock an update to the branch prediction table based on a number of branches in the prediction table.

Example 35 includes the at least one non-transitory one machine readable medium of any of Examples 32 to 34, comprising a plurality of further instructions that, in response to being executed on the computing device, cause the computing device to initially block the branch prediction in response to the mode transition if a transitioned-to mode is a more privileged mode as compared to a transitioned-from mode.

Example 36 includes the at least one non-transitory one machine readable medium of Example 35, comprising a plurality of further instructions that, in response to being executed on the computing device, cause the computing device to maintain a branch prediction table and a history length of the branch prediction table, and continue to block the branch prediction from the branch prediction table after the mode transition to the more privileged mode based on the history length of the branch prediction table.

Example 37 includes the at least one non-transitory one machine readable medium of Example 36, comprising a plurality of further instructions that, in response to being executed on the computing device, cause the computing device to unblock the branch prediction from the branch prediction table in the more privileged mode after a number of branches equal to the history length have retired.

Example 38 includes the at least one non-transitory one machine readable medium of any of Examples 33 to 37, wherein the branch prediction table corresponds to an indirect branch prediction table.

Example 39 includes the at least one non-transitory one machine readable medium of any of Examples 32 to 38, comprising a plurality of further instructions that, in response to being executed on the computing device, cause the computing device to count a number of taken branches after the mode transition, and selectively block and unblock the branch prediction based at least in part on the counted number of taken branches after the mode transition.

Example 40 includes an apparatus comprising means for providing a history-based branch prediction for one or more instructions to be executed, and means for selectively blocking and unblocking a branch prediction after a mode transition.

Example 41 includes the apparatus of Example 40, further comprising means for maintaining a branch prediction table, and means for selectively blocking and unblocking a branch prediction from the branch prediction table based on a number of branches in the branch prediction table.

Example 42 includes the apparatus of any of Examples 40 to 41, further comprising means for maintaining a branch prediction table, and means for selectively blocking and unblocking an update to the branch prediction table based on a number of branches in the prediction table.

Example 43 includes the apparatus of any of Examples 40 to 42, further comprising means for initially blocking the branch prediction in response to the mode transition if a transitioned-to mode is a more privileged mode as compared to a transitioned-from mode.

Example 44 includes the apparatus of Example 43, further comprising means for maintaining a branch prediction table and a history length of the branch prediction table, and means for continuing to block the branch prediction from the branch prediction table after the mode transition to the more privileged mode based on the history length of the branch prediction table.

Example 45 includes the apparatus of Example 44, further comprising means for unblocking the branch prediction from the branch prediction table in the more privileged mode after a number of branches equal to the history length have retired.

Example 46 includes the apparatus of any of Examples 41 to 45, wherein the branch prediction table corresponds tan indirect branch prediction table.

Example 47 includes the apparatus of any of Examples 40 to 46, further comprising means for counting a number of taken branches after the mode transition, and means for selectively blocking and unblocking the branch prediction based at least in part on the counted number of taken branches after the mode transition.

Example 48 includes at least one non-transitory one machine readable medium comprising a plurality of instructions that, in response to being executed on a computing device, cause the computing device to decode one or more instructions, provide a branch prediction for the one or more decoded instructions based on one or more prediction tables, selectively block and unblock a branch prediction from one or more of the one or more prediction tables after a transition from a first mode to a second mode, and execute the one or more decoded instructions.

Example 49 includes the at least one non-transitory one machine readable medium of Example 48, comprising a plurality of further instructions that, in response to being executed on the computing device, cause the computing device to provide one or more counters to count a number of taken branches encountered after the transition from the first mode to the second mode.

Example 50 includes the at least one non-transitory one machine readable medium of Example 49, comprising a plurality of further instructions that, in response to being executed on the computing device, cause the computing device to selectively block and unblock the branch prediction from one or more of the one or more prediction tables based at least in part on respective values of the one or more counters and respective lengths of the one or more prediction tables.

Example 51 includes the at least one non-transitory one machine readable medium of any of Examples 49 to 50, comprising a plurality of further instructions that, in response to being executed on the computing device, cause the computing device to reset the one or more counters to zero in response to the transition from the first mode to the second mode.

Example 52 includes the at least one non-transitory one machine readable medium of Example 51, comprising a plurality of further instructions that, in response to being executed on the computing device, cause the computing device to increment an associated counter of the one or more counters in response to any taken branch.

Example 53 includes the at least one non-transitory one machine readable medium of Example 52, comprising a plurality of further instructions that, in response to being executed on the computing device, cause the computing device to force a miss for any of the one or more prediction tables that have a length that is less than or equal to respective associated values of the one or more counters.

Example 54 includes the at least one non-transitory one machine readable medium of any of Examples 51 to 53, comprising a plurality of further instructions that, in response to being executed on the computing device, cause the computing device to block one or more of an update and allocation for any of the one or more prediction tables that have a length that is less than or equal to respective associated values of the one or more counters.

Example 55 includes an apparatus comprising means for decoding one or more instructions, means for providing a branch prediction for the one or more decoded instructions based on one or more prediction tables, means for selectively blocking and unblocking a branch prediction from one or more of the one or more prediction tables after a transition from a first mode to a second mode, and means for executing the one or more decoded instructions.

Example 56 includes the apparatus of Example 55, further comprising means for providing one or more counters to count a number of taken branches encountered after the transition from the first mode to the second mode.

Example 57 includes the apparatus of Example 56, further comprising means for selectively blocking and unblocking the branch prediction from one or more of the one or more prediction tables based on respective values of the one or more counters and respective lengths of the one or more prediction tables.

Example 58 includes the apparatus of any of Examples 56 to 57, further comprising means for resetting the one or more counters to zero in response to the transition from the first mode to the second mode.

Example 59 includes the apparatus of Example 58, further comprising means for incrementing an associated counter of the one or more counters in response to any taken branch.

Example 60 includes the apparatus of Example 59, further comprising means for forcing a miss for any of the one or more prediction tables that have a length that is less than or equal to respective associated values of the one or more counters.

Example 61 includes the apparatus of any of Examples 58 to 60, further comprising means for blocking one or more of an update and allocation for any of the one or more prediction tables that have a length that is less than or equal to respective associated values of the one or more counters.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain examples also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain examples are not described with reference to any particular programming language. It will be appreciated that a variety of programming languages may be used to implement the teachings of such examples as described herein.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
first circuitry to provide a history-based prediction; and
second circuitry coupled to the first circuitry to selectively block and unblock a prediction from the first circuitry after a mode transition.

2. The apparatus of claim 1, wherein the first circuitry is further to maintain a prediction table, and wherein the second circuitry is further to:
selectively block and unblock a prediction from the prediction table based on a number of branches that represent a history utilized by the prediction table.

3. The apparatus of claim 1, wherein the first circuitry is further to maintain a prediction table, and wherein the second circuitry is further to:
selectively block and unblock an update to the prediction table based on a number of branches that represent a history utilized by the prediction table.

4. The apparatus of claim 1, wherein the second circuitry is further to:
initially block the prediction from the first circuitry in response to the mode transition if a transitioned-to mode is a more privileged mode as compared to a transitioned-from mode.

5. The apparatus of claim 4, wherein the first circuitry is further to maintain a prediction table and a history length of the prediction table, and wherein the second circuitry is further to:
continue to block the prediction from the prediction table after the mode transition to the more privileged mode based on the history length of the prediction table.

6. The apparatus of claim 5, wherein the second circuitry is further to:
unblock the prediction from the prediction table in the more privileged mode after a number of branches equal to the history length have retired.

7. The apparatus of claim 5, wherein the prediction table corresponds to an indirect prediction table.

8. The apparatus of claim 1, wherein the second circuitry is further to:
maintain a count of taken branches after the mode transition; and
selectively block and unblock the prediction from the first circuitry based at least in part on the count of taken branches after the mode transition.

9. A method comprising:
providing a history-based branch prediction for one or more instructions to be executed; and
selectively blocking and unblocking a branch prediction after a mode transition.

10. The method of claim 9, further comprising:
maintaining a branch prediction table; and
selectively blocking and unblocking a branch prediction from the branch prediction table based at least in part on a number of branches in the branch prediction table.

11. The method of claim 9, further comprising:
maintaining a branch prediction table; and
selectively blocking and unblocking an update to the branch prediction table based at least in part on a number of branches in the prediction table.

12. The method of claim 9, further comprising:
initially blocking the branch prediction in response to the mode transition if a transitioned-to mode is a more privileged mode as compared to a transitioned-from mode.

13. The method of claim 12, further comprising:
maintaining a branch prediction table and a history length of the branch prediction table; and
continuing to block the branch prediction from the branch prediction table after the mode transition to the more privileged mode based at least in part on the history length of the branch prediction table.

14. The method of claim 13, further comprising:
unblocking the branch prediction from the branch prediction table in the more privileged mode after a number of branches equal to the history length have retired.

15. The method of claim 14, wherein the branch prediction table corresponds to an indirect branch prediction table.

16. The method of claim 9, further comprising:
counting a number of taken branches after the mode transition; and
selectively blocking and unblocking the branch prediction based at least in part on the counted number of taken branches after the mode transition.

17. An apparatus comprising:
a first unit to decode one or more instructions; and
a second unit coupled to the first unit to execute the one or more decoded instructions, the first unit including:
first circuitry to provide a branch prediction based on one or more prediction tables; and
second circuitry coupled to the first circuitry to selectively block and unblock a branch prediction from one or more of the one or more prediction tables after a transition from a first mode to a second mode.

18. The apparatus of claim 17, wherein the second circuitry further comprises:
one or more counters respectively associated with the one or more prediction tables to count a number of taken branches encountered after the transition from the first mode to the second mode.

19. The apparatus of claim 18, wherein the second circuitry is further to:
selectively block and unblock the branch prediction from one or more of the one or more prediction tables based at least in part on respective values of the one or more counters and respective lengths of the one or more prediction tables.

20. The apparatus of claim 18, wherein the second circuitry is further to:
reset the one or more counters to zero in response to the transition from the first mode to the second mode.

21. The apparatus of claim 20, wherein the second circuitry is further to:
increment an associated counter of the one or more counters in response to any taken branch.

22. The apparatus of claim 21, wherein the second circuitry is further to:
force a miss for any of the one or more prediction tables that have a length that is less than or equal to respective associated values of the one or more counters.

23. The apparatus of claim 21, wherein the second circuitry is further to:
block one or more of an update and allocation for any of the one or more prediction tables that have a length that is less than or equal to respective associated values of the one or more counters.

24. The apparatus of claim 17, wherein the first unit corresponds to a front-end unit and the second unit corresponds to a back-end unit.
